(19) United States
(12) Patent Application Publication
(10) Pub. No.: US 2015/0354768 A1
(43) Pub. Date: Dec. 10, 2015

(54) CONSUMER RETROFIT KIT

(71) Applicant: Jörn GAUMANN, Dortmund (DE)

(72) Inventor: Joern GAUMANN, Dortmund (DE)

(21) Appl. No.: 14/760,654

(22) PCT Filed: Jan. 14, 2013
(86) PCT No.: PCT/EP2013/050544

§ 371 Date: Jul. 13, 2015

(51) Int. Cl. F21S 9/03; H02J 7/35; F21V 21/08; F21V 21/02; F21S 4/00; F21V 23/06

(52) U.S. Cl. CPC F21S 9/03; F21S 4/001; F21V 23/06; F21V 21/0824; F21V 21/02; H02J 7/35; F21W 2121/04

(57) ABSTRACT

A consumer, having at least one solar panel and at least one consumer, is intended to be used both in the outer area, i.e. in the open air, and in the inner area, i.e. in the domestic environment. This is also achieved in that it also has at least one separate accumulator, at least one line adapter and at least one separate line, wherein the consumer has a connection.

The invention relates to a consumer retrofit kit, particularly to a light retrofit kit, in accordance with the preamble of claim 1.

Consumer retrofit sets are known from the state of the art and are disclosed, for example in the form of light retrofit kits, in the documents DE 20 2009 006 888 U1 and DE 202 16 505 U1.

A consumer retrofit kit of the type stated initially is described in WO 2007/121765 A1. This previously known consumer retrofit kit is particularly provided for existing lighting fixtures in the form of mast attachment lights that are operated with solar energy. In order to retrofit an existing mast attachment light, a retrofit set is furthermore disclosed in WO 2007/121765 A1, which has solar cells as well as rechargeable batteries in the form of gel rechargeable batteries, among other things. By means of the installation of the solar cells, of the rechargeable batteries, of corresponding electronics, and of LEDs, the result is achieved that existing lighting fixtures in the form of mast attachment lights can continue to be used.

It is emphasized as an advantage in WO 2007/121765 A1 that renewable and therefore environmentally friendly energies can be used for the public sector by means of retrofitting existing lighting fixtures. Furthermore, an alternative retrofit kit is disclosed in WO 2007/121765 A1, which has not only LEDs but also a power transformer, wherein the power transformer can be connected with a power cable in the lighting fixture. A reduced connection power is viewed as an advantage of this alternative light retrofit kit, and this in turn results in increased electricity savings.

It is surely a disadvantage of the previously known consumer retrofit kit that generating electricity for the lighting fixture is considered solely from the aspect of saving electricity and of environmental compatibility. Particularly in the case of lighting fixtures for private use, however, the consumer frequently has the need to use lighting fixtures in the open and in an area that is closed off toward the outside.

For example, chains of lights are often used for decorative purposes both indoors and outdoors. For example, chains of lights, in particular, are used for the purpose of Christmas decorations during the dark time of year, whereas chains of lights are frequently used for outdoor decoration for other occasions, for example garden parties, during the brighter time of year.

A consumer retrofit kit of the type stated initially is only suitable for this purpose with restrictions, or hardly at all, since solar panels are only insufficiently usable for indoor use or for the home environment.

It is therefore the task of the present invention to make available a retrofit kit of the type stated initially, the components of which can be used both outdoors, i.e. in the open, and indoors, i.e. in the home environment.

This task is accomplished with the characteristics of claim 1. Advantageous embodiments are evident from the dependent claims.

The invention provides that the consumer retrofit kit has further components. These include at least one separate rechargeable battery, at least one power adapter, as well as at least one separate line. According to the invention, the consumer has a connector, in this connection. The additional rechargeable battery is separate, i.e. it is not integrated into the solar panel or into the consumer.

It is the core idea of the invention to design a consumer retrofit kit, the consumer of which can be used both in the open and in a region that is closed off toward the outside, such as, for example, in the home sector.

It is the advantage of the invention that the user can flexibly use a consumer, independent of the time of year, in the open and in a region that is closed off toward the outside. For example, a lighting fixture operated exclusively with solar energy can be used only very insufficiently or not at all in a region that is closed off toward the outside. In the open, in contrast, users frequently do not have a power connection. By means of the consumer according to the invention, the user is enabled to use consumers, independent of the time of year, even over an extended period of time.

Because the consumer retrofit kit according to the invention additionally has a power adapter and at least one separate line, it is guaranteed that a connection to the household electricity connection can be made by way of the separate line and the power adapter. The separate line can be configured as a conventional power cable or as a USB line.

In order to make high-power rechargeable batteries available, advantageous further developments of the invention provide that the separate rechargeable battery and/or the rechargeable battery in the solar panel is a lithium ion battery or a lithium iron phosphate battery.

In order to utilize the advantages of serial bus systems, a practical variant of the invention provides that the connection lines for the consumer, for the power adapter, and for the solar panel are configured as USB connection lines.

It is advantageous if the solar panel can be positioned in different ways. Preferably, the solar panel can be set up on the ground, by means of a spike, or can be attached to the wall, by means of a wall bracket. It is practical if the consumer retrofit kit comprises appropriate means of attachment for this purpose.

Further advantageous embodiments of the invention therefore provide that consumers in the form of lighting fixtures are present and that lighting fixtures in the form of a chain of lights, of little fiber optic trees, of door and window wreaths, as well as of Christmas garlands are present. However, smaller fans, among other things, are also possible consumers.

In the following, the invention will be described in greater detail using the drawings. These show, in a schematic representation:

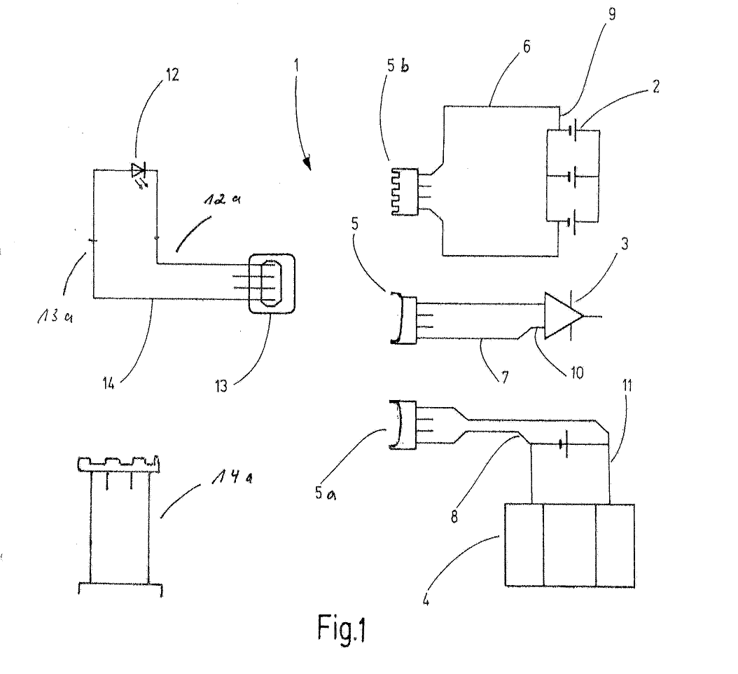

FIG. 1 the components of the consumer retrofit kit according to the invention as wiring diagrams,

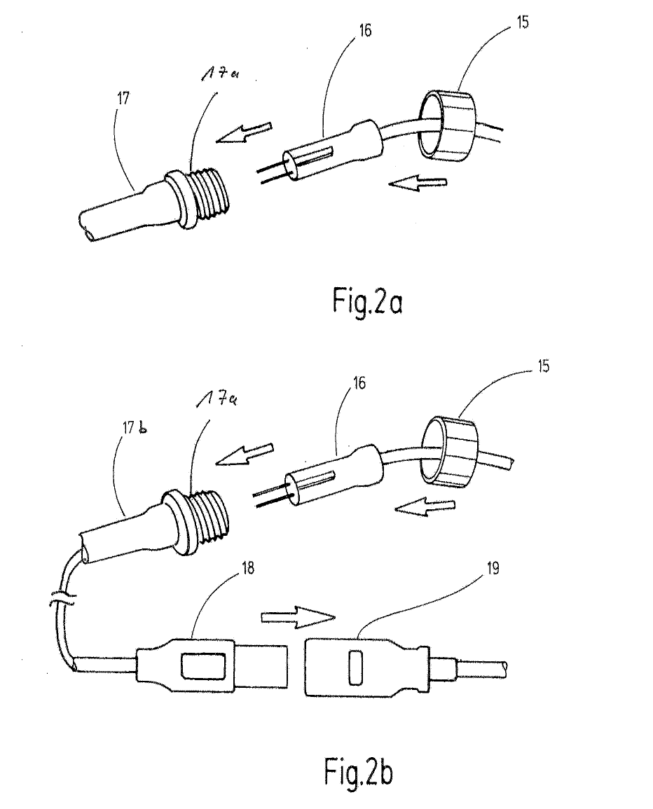

FIGS. 2a and 2b the connection mechanism in the case of a connection between consumer and solar panel and in the case of a connection between consumer and power adapter, and

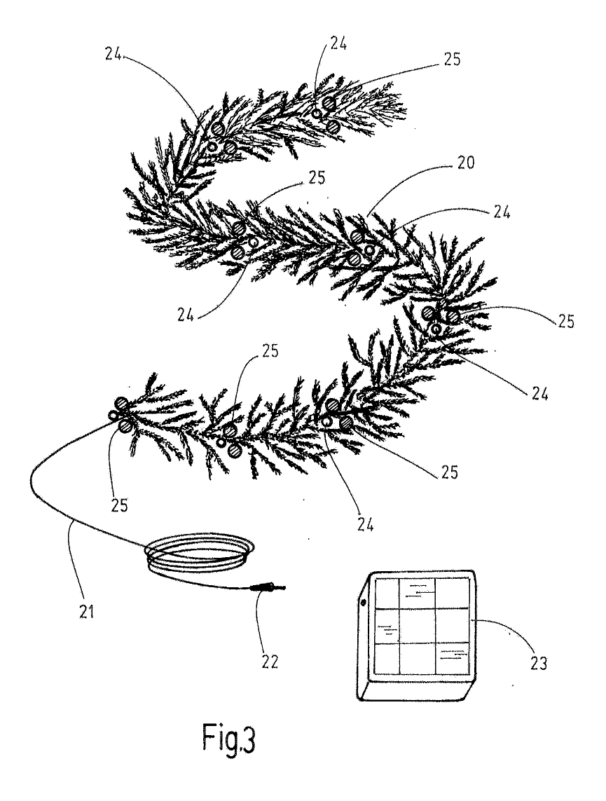

FIG. 3 a consumer in the form of a pine garland, wherein the consumer can be connected with a solar panel.

FIG. 1 shows the consumer retrofit kit according to the invention, indicated as 1. The consumer retrofit kit 1 shown has multiple components, which allow use of the consumer 12a in the form of the lighting fixture having the illuminant 12 both in the open and in a region closed off toward the outside, such as, for example, in a residence or in a building.

For use of the lighting fixture in the open, the consumer retrofit kit 1 contains the solar panel 4, which has a replaceable rechargeable battery and the connector 11, at which the connection line 8 is connected with the outlet 5a. The separate rechargeable battery 2, which can also be charged by way of the solar panel 4, is present in the form of a lithium ion battery and has a connector 9 as well as a connection line 6 having the plug 5b. In order to produce the connection between solar panel 4 and consumer, i.e. lighting fixture 12, the consumer 12a contains a plug 13 corresponding to the outlet 5a of the solar panels 4, as part of the connector 14, which is connected with the consumer 12a by way of the connector 13a.

In order to be able to use the consumer 12a in a region that is closed off toward the outside, the consumer retrofit kit 1, as is further evident from FIG. 1, has a power adapter 3. The power adapter 3 has a connector 10 as well as a connection line 7 with the outlet 5. As a further component for use of the consumer 12a in a region closed off toward the outside, a separate line 14a is provided. This separate line 14a has a plug and an outlet and represents the connection between consumer 12a and power adapter 3 in the state of use.

FIGS. 2a and 2b illustrate the connection mechanism when the solar panel 4 shown in FIG. 1 and the power adapter 3 shown in FIG. 1 are connected with the consumer 12a shown in FIG. 1. As is evident from FIG. 2a, the plug of the consumer 12a shown in FIG. 1, now provided with the reference symbol 16, is connected with the outlet of the solar panel 4 shown in FIG. 1, which outlet corresponds to the plug 16 and is now provided with the reference symbol 17. The connection is secured with the closure cap 15, which lies loosely on the connection cable, in that it is tightened onto the counter-thread 17a of the outlet 17. In this way, the connection is also protected against sprayed water.

The connection mechanism in a region that is closed off toward the outside is shown in FIG. 2b. As is evident from FIG. 2b, the plug 16 of the consumer 12a shown in FIG. 1 is connected with the corresponding outlet 17b of the separate line 14a shown in FIG. 1. In the embodiment shown in FIG. 2b, the separate line 14a is present as a USB cable. The connection shown in FIG. 2b is also secured with the closure cap 15, which lies loosely on the cable, in that it is tightened onto the counter-thread 17a of the outlet 17b of the separate line 14a. The separate line 14a that is present in the form of a USB cable is finally connected with the USB plug, which now bears the reference symbol 19, of the power adapter 3 shown in FIG. 1, by way of the plug 18.

The consumer 12a shown in FIG. 1 can be configured differently for decoration purposes as a lighting fixture. FIG. 3 shows a pine garland 20 having lights 24 and ornaments 25, which garland can be connected with the solar panel 23 using the plug 22, by way of a connection cable 21.

The present invention is not restricted, in terms of its embodiment, to the exemplary embodiment indicated above. Instead, a number of variants is conceivable, which make use of the solution presented also in embodiments of a different type. For example, different rechargeable battery types (for example derivatives of a lithium ion battery) or illuminants can be used as the rechargeable battery 2 as well as the rechargeable battery in the solar panel 4 and as illuminants 12. Also, the consumer 12a is not, of course, restricted to a lighting fixture. It is also conceivable that the separate rechargeable battery 2 can be charged via a power cable/outlet.

### REFERENCE SYMBOL LIST

1 light retrofit kit
2 rechargeable battery
3 power adapter
4 solar panel
5, 5a, 17 power outlet
5b, 13, 16, 18, 22 plug
6, 7, 8 connection line
9, 10, 11 connector
12 illuminant
12a consumer
14 connection line
14a separate line
15 closure cap
17a counter-thread
19 USB plug
20 pine garland
21 connection cable
23 solar panel
24 lights
25 ornaments

1. Consumer retrofit kit (1), particularly light retrofit kit, having:
at least one solar panel (4) having a rechargeable battery,
at least one consumer (12a),
wherein
it furthermore has:
at least one separate rechargeable battery (2),
at least one power adapter (3),
at least one separate line (14a), wherein the consumer (12a) has a connector (14).

2. Retrofit kit according to claim 1,
wherein
the line (14a) is a USB line.

3. Retrofit kit according to claim 1,
wherein
the separate rechargeable battery (2) and/or the rechargeable battery in the solar panel (4) is a lithium ion battery or a lithium iron phosphate battery.

4. Retrofit kit according to claim 1,
wherein
the consumer (12a) has a USB connection line.

5. Retrofit kit according to claim 1,
wherein
the power adapter (3) has a USB connection line.

6. Retrofit kit according to claim 1,
wherein
the power adapter (3) is a USB power adapter.

7. Retrofit kit according to claim 1,
wherein
the line (14a) can be connected with the power adapter (3) and/or with the consumer (12a).

8. Retrofit kit according to claim 1,
wherein
the solar panel (4) has a USB connector.

9. Retrofit kit according to claim 1,
wherein
it has attachment means, a spike, a wall bracket.

10. Retrofit kit according to on claim 1,
wherein
the solar panel (4) has a USB connection line.

11. Retrofit kit according to claim 1,
wherein
the consumer (12a) is a lighting fixture, wherein an illuminant (12) is integrated into the lighting fixture.

12. Retrofit kit according to claim 11,
wherein
the lighting fixture is a chain of lights, a small fiber optic tree or a door or window wreath and/or a Christmas garland.
